(19) United States
(12) Patent Application Publication
(10) Pub. No.: US 2008/0174783 A1
(43) Pub. Date: Jul. 24, 2008

(54) SYSTEM AND METHOD OF INTERFEROMETRIC IMAGING USING A DIGITAL MICROMIRROR DEVICE

(76) Inventor: Michael J. Mater, Chelsea, MI (US)

Correspondence Address: SCHOX PLC, 730 Florida Street #2, San Francisco, CA, 94110, US

(21) Appl. No.: 11/958,293

(22) Filed: Dec. 17, 2007

Related U.S. Application Data
(60) Provisional application No. 60/870,108, filed on Dec. 15, 2006.

(51) Int. Cl. G01B 9/02; G02B 26/08

(52) U.S. Cl. 356/511; 359/223

(57) ABSTRACT

A method of interferometric imaging includes a) focusing an interference pattern of a surface of an object onto a digital micromirror device, b) reflecting interfered electromagnetic radiation from a first plurality of mirrors of the digital micromirror device onto a detector, and recording the integrated intensity of the reflected interferometric radiation, repeating step b) for a second plurality of mirrors, and computing the interference pattern of the surface of the object from the recorded integrated intensities.

### CROSS-REFERENCE TO RELATED APPLICATIONS

This application claims the benefit of U.S. Provisional Application No. 60/870,108, filed 15 Dec. 2006, which is incorporated in its entirety by this reference.

### TECHNICAL FIELD

This invention relates generally to the interferometric imaging field, and more specifically to a new and useful system and method of interferometric imaging using a digital micromirror device.

### BRIEF DESCRIPTION OF THE FIGURES

FIG. 1 is a flowchart representation of a first preferred embodiment of the invention.

FIG. 2 is a flowchart representation of a variation of a first preferred embodiment of the invention.

FIG. 3 is a schematic drawing of a first variation of a second preferred embodiment of the invention.

FIG. 4 is a schematic drawing of a second variation of a second preferred embodiment of the invention.

FIG. 5 is a schematic drawing of a third variation of a second preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method of Interferometric Imaging

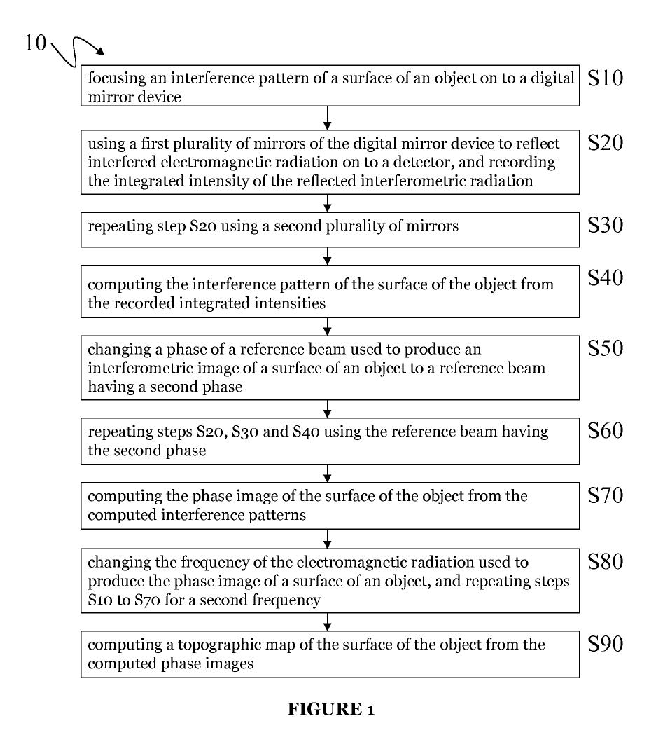

As shown in FIG. 1, a method 10 of interferometric imaging according to the first preferred embodiment of the invention includes focusing an interference pattern of a surface of an object onto a digital micromirror device S10, using a first plurality of mirrors of the digital micromirror device to reflect interfered electromagnetic radiation onto a detector, and recording the integrated intensity of the reflected interferometric radiation S20, repeating step S20 using a second plurality of mirrors S30, computing the interference pattern of the surface of the object from the recorded integrated intensities S40.

Step S10, which recites focusing an interference pattern of a surface of an object onto a digital micromirror device, functions to focus an interference pattern from an optical subsystem of an interferometric imaging system onto a Digital Micromirror Device. A Digital Micromirror Device, or DMD, is an optical semiconductor invented by Larry Hornbeck and William Nelson and described in U.S. Pat. No. 4,571,603, which is incorporated in its entirety by this reference. A typical DMD has on its surface several hundred thousand microscopic mirrors arranged in a rectangular array that correspond to the pixels an the image. The mirrors can be individually rotated ±10-12°, to an on or off state. Light is reflected in the on state, and directed elsewhere in the off state.

Step S20, which recites using a first plurality of mirrors of the digital micromirror device to reflect interfered electromagnetic radiation onto a detector, and recording the integrated intensity of the reflected interferometric radiation, functions to capture an intensity profile of the reflected radiation.

Step S30, which recites repeating step S20 using a second plurality of mirrors, functions to reflect interfered electromagnetic radiation onto a detector, and recording the integrated intensity of the reflected interferometric radiation, preferably using a different pattern of mirrors, preferably captures a second intensity profile of the reflected radiation.

Step S40, which recites computing the interference pattern of the surface of the object from the recorded integrated intensities, functions to generate an interference pattern which is preferably produced from a nearly flat object such as a piece of optical glass.

For an object with a rougher surface or with a great degree of speckle, the method preferably also includes: changing a phase of a reference beam used to produce an interferometric image of a surface of an object to a reference beam having a second phase S50, repeating steps S20, S30 and S40 using the reference beam having the second phase S60 (which functions to compute additional interference patterns of the surface of the object from the recorded integrated intensities, and computeing the phase image of the surface of the object from the computed interference patterns to produce a phase image S70 (which provides better imaging of rough or highly speckled surfaces).

The phase image produced in S70 is useful if there is a priori knowledge that the surface does not have steps greater than half the wavelength of the electromagnetic radiation illuminating the surface. Otherwise, the phase ambiguity may be resolved using the methods of multiwavelength interferometric imaging, preferably performed by changing the frequency of the electromagnetic radiation used to produce the phase image of a surface of an object and repeating steps S10 to S70 for a second frequency (which functions to produce additional interference patterns and phase images using at least one additional frequency, preferably an entire range of frequencies with a tunable laser), and computing a topographic map of the surface of the object from the computed phase images (which functions to compute a topographic map using the phase images generated from multiple frequencies, and multiple interference pattern images).

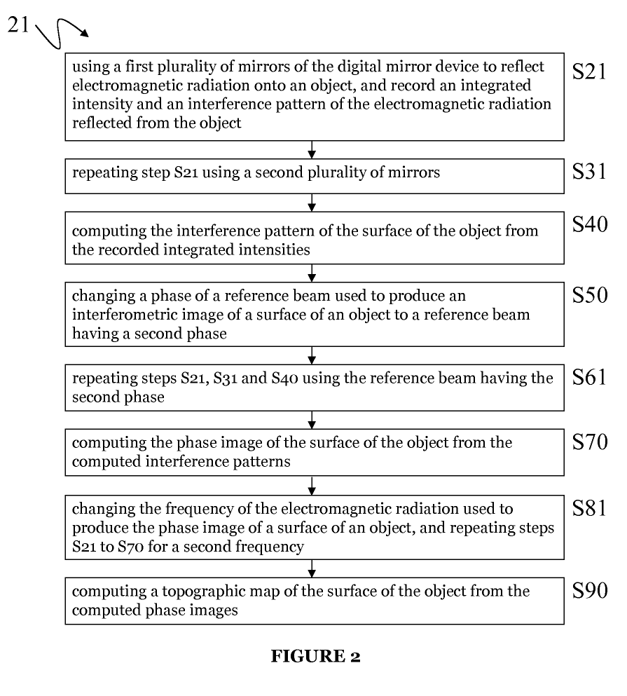

As shown in FIG. 2, Steps S40, S50, S70, and S90 of the first variation of the first preferred embodiment of the method 21 are preferably identical to the steps introduced with identical numbers as in FIG. 1. Except as noted below, Steps S21, S31, S61 and S81 of the first variation of the first preferred embodiment are preferably similar to Steps S20, S30, S60, and S80 of the first preferred embodiment.

Step S21, which recites using a first plurality of mirrors of the digital micromirror device to reflect electromagnetic radiation onto an object and record an integrated intensity and an interference patter of the electromagnetic radiation reflected from the object, functions to focus light onto an object through the use of a digital micromirror device.

Step S31 preferably repeats step S21 instead of step S20. Step S61 preferably repeats steps S21, S31, and S40 instead of step S20, S30 and S40, respectfully. Step S81 preferably repeats steps S21, S31, S40, S50, S61 and S70 instead of S20, S30, S40, S50, S60, and S71, respectfully.

### 2. Interferometic Imaging System

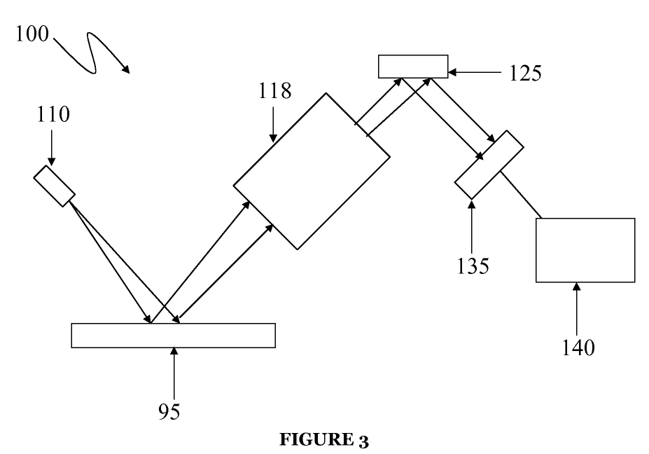

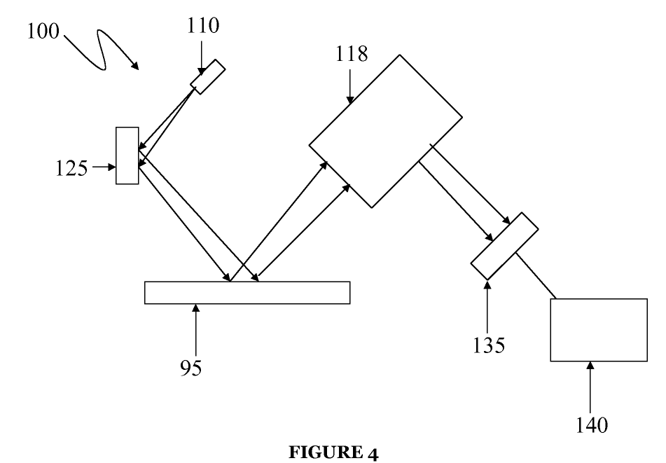

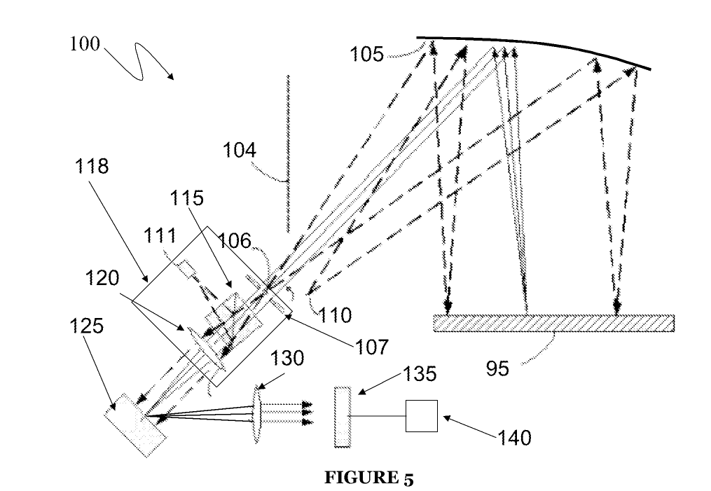

As shown in FIGS. 3-5, a digital micromirror device (DMD) is preferably used to adjust the intensity of each interferometric image produced by the interferometric imaging system. An interference pattern is focused on the DMD surface, and electromagnetic radiation reflected from a selected plurality of mirrors is collected and the intensity of the electromagnetic radiation recorded by a detector in FIG. 3 and FIG. 5. An electromagnetic radiation source reflects electromagnetic radiation off the surface of a DMD and onto an object for an interferometric imaging system is shown in FIG. 4. As shown in FIGS. 3-5, the pattern of mirrors is then changed, and a new measurement of the intensity of the electromagnetic radiation is recorded. The recordings of intensity are used to reproduce the interference pattern imaged on the DMD array in FIGS. 3 and 5.

As shown in FIGS. 3 and 5, an interferometic imaging system 100 according to the second preferred embodiment of the invention includes an electromagnetic radiation source 11o oriented to emit electromagnetic radiation onto an object 95, an optical subsystem 118 that optically processes the electromagnetic radiation to produce an object beam and a reference beam, a digital micromirror device 125 that reflects the object beam and the reference beam from the optical subsystem 118 onto a detector 135, a detector 135 that receives the object beam and the reference beam from the digital micromirror device 125, and a processor 140 that processes images from the detector 135.

The electromagnetic radiation source 11o functions to emit electromagnetic radiation onto the object. The electromagnetic radiation source 11o is preferably a tunable laser, of the type usually used for communications. Such lasers have wavelength in the region of 1.3 and 1.5 microns, and do not record on silicon CCD and CMOS image receiver arrays. Alternatively, the electromagnetic radiation source 100 may also be longer wavelength tunable lasers in the 10-20 micron wavelength region. Many objects of interest have the surface topography known within such wavelengths, and a single wavelength is sufficient to produce a topographic map with no ambiguity. Alternatively, the electromagnetic radiation source 110 may be an optical fiber, a diode laser, an LED or any other suitable electromagnetic radiation source.

The optical subsystem 118 functions to receive electromagnetic illumination reflected from the object and focus the non-specularly reflected electromagnetic radiation, preferably using a lens 120. As shown in FIG. 5, the optical subsystem 118 preferably includes a beam combiner 115 (also known to those skilled in the art as a beam splitter) to combine the electromagnetic radiation reflected from the object 95 (also known as the object beam) with a reference beam, from an additional electromagnetic radiation source 111. In one alternative, the optical subsystem 118 includes a plate that defines an aperture to define the cone of electromagnetic radiation entering the optical subsystem. In one alternative, the specularly reflected electromagnetic radiation is collimated and used as a reference beam instead of a beam combiner 115 and additional electromagnetic radiation source 111.

The digital micromirror device (DMD) 125 functions to reflect electromagnetic radiation from the optical subsystem 118 onto the detector 135. Preferably, the patterns of the mirrors are set to capture electromagnetic radiation from a plurality of mirrors. After recording the integrated intensity from those mirrors, the mirror positions are changed so that a different plurality of mirrors directs electromagnetic radiation into the detector 135. In one variation the DMD mirrors can be switched one at time to give a stream of measurements from which the intensity of the interference pattern on the DMD 125 can be reconstructed.

The detector 135 functions to record the intensities of interferometric images received, and to record interferometric image patterns. The detector 135 is preferably a charge-coupled device (CCD). The stream recorded intensities are preferably sent to a processor 140.

The processor 140 functions to reconstruct the image from the stream if the positions of the DMD mirrors for each recorded intensity are known. One example of an image reconstruction method yielding data compression for data transmission is noted in U.S. Pub. No. 2006/0239336, which is incorporated in its entirety by this reference. The loss of information in such compressions may be acceptable for some aspects of interferometric imaging. In the most preferred method of the invention, no data is lost, and the image may be reconstructed with resolution of the DMD itself. In one variation, it is possible to increase the resolution over that of the DMD itself by using knowledge about the actual image and using multiple “exposures” of the image with some variation of a parameter. A variation of the phase of the reference beam used to produce interference patterns may be combined to give a phase image of a surface.

As shown in FIG. 5, in one variation, the system 100 includes a parabolic mirror 105. The parabolic mirror 105 functions to reflect the electromagnetic radiation from the electromagnetic radiation source 110 onto the object 95. The parabolic mirror 105 is preferably oriented off of the optical axis 104 such that the electromagnetic radiation from the electromagnetic radiation source 110 is reflected onto the object 95, and the object 95 preferably does not intersect the optical axis 104 of the parabolic mirror 105. The parabolic mirror preferably reflects the specularly reflecting beams (from the object surface) to a focus point 106, and non-specularly reflected beams (from the object surface) in a collimated beam to the optical subsystem 118. Preferably, both the collimated and the unfocused electromagnetic radiation from both the specularly reflected beam and the non-specularly reflected beam enter the optical subsystem 118. The electromagnetic radiation source 110 is preferably located a significant optical distance from the focus point of the parabolic mirror 105, more preferably half the focal length from the focus point.

As shown in FIG. 4, a variation of the preferred system 100 includes an electromagnetic radiation source 110, a digital micromirror device 125 that reflects the emitted electromagnetic radiation onto an object 95, an optical subsystem 118, wherein the optical subsystem 118 focuses the electromagnetic radiation reflected from the object into an object beam, a detector 135 that receives the object beam and the reference beam from the optical subsystem 118, and a processor 140 that processes images from the detector 135. Except as noted below, the elements of the variation of the preferred system are identical to the elements of the preferred system of the second preferred embodiment of the invention.

The digital micromirror device 125 functions to reflect electromagnetic radiation from the electromagnetic radiation source 110 onto the object 95. Pluralities of mirrors of the digital micromirror device 125 are preferably controlled by the processor 140 to adjust the contrast of the illumination of the object 95, and thus the overall quality of interferometric images received at the detector 135.

As a person skilled in the art will recognize from the previous detailed description and from the figures and claims, modifications and changes can be made to the preferred embodiments of the invention without departing from the scope of this invention defined in the following claims.

I claim:

1. A method of interferometric imaging, comprising:
a) focusing an interference pattern of a surface of an object onto a digital micromirror device;
b) using a first plurality of mirrors of the digital micromirror device to reflect interfered electromagnetic radiation onto a detector, and recording the integrated intensity of the reflected interferometric radiation;
c) repeating step b) using a second plurality of mirrors;
d) computing the interference pattern of the surface of the object from the recorded integrated intensities.

2. The method of claim 1, further comprising the step of repeating step b) using a third plurality of mirrors.

3. The method of claim 1, further comprising;
e) changing a phase of a reference beam used to produce an interferometric image of a surface of an object to a reference beam having a second phase;
f) repeating steps b), c) and d) using the reference beam having the second phase; and
g) computing the phase image of the surface of the object from the computed interference patterns.

4. The method of claim 3, further comprising repeating steps e) and f) for a reference beam having a third phase.

5. The method of claim 3, further comprising;
h) changing the frequency of the electromagnetic radiation used to produce the phase image of a surface of an object, and repeating steps a) to g) for a second frequency; and
i) computing a topographic map of the surface of the object from the computed phase images.

6. The method of claim 5, further comprising changing the frequency of the electromagnetic radiation used to produce the phase image of a surface of an object, and repeating steps a) through g) for a third frequency.

7. The method of claim 1, further comprising generating an image with a resolution greater than the resolution of the digital micromirror device from multiple images captured with a varying phase of a reference beam.

8. The method of claim 1, further comprising generating an image with a resolution greater than the resolution of the digital micromirror device from multiple images captured with a varying position of the digital micromirror device.

9. A method of interferometric imaging, comprising:
a) using a first plurality of mirrors of the digital micromirror device to reflect electromagnetic radiation onto an object, and record an integrated intensity and an interference pattern of the electromagnetic radiation reflected from the object;
b) repeating step a) using a second plurality of mirrors;
c) computing the interference pattern of the surface of the object from the recorded integrated intensities.

10. The method of claim 9, further comprising;
d) changing a phase of a reference beam used to produce an interferometric image of a surface of an object to a reference beam having a second phase;
e) repeating steps a), b) and c) using the reference beam having the second phase; and
f) computing the phase image of the surface of the object from the computed interference patterns.

11. The method of claim 10, further comprising;
g) changing the frequency of the electromagnetic radiation used to produce the phase image of a surface of an object, and repeating steps a) to f) for a second frequency; and
h) computing a topographic map of the surface of the object from the computed phase images.

12. An interferometric imaging system, comprising:
an electromagnetic radiation source, oriented to emit electromagnetic radiation onto an object;
an optical subsystem, wherein the optical subsystem optically processes the electromagnetic radiation to produce an object beam and a reference beam;
a digital micromirror device that reflects the object beam and the reference beam from the optical subsystem onto a detector;
a detector that receives the object beam and the reference beam from the digital micromirror device; and
a processor that processes images from the detector.

13. The system of claim 12, wherein the optical subsystem comprises a lens, wherein the lens collimates specularly reflected electromagnetic radiation, and focuses non-specularly reflected electromagnetic radiation.

14. The system of claim 13, wherein the optical subsystem comprises a beam combiner and an additional electromagnetic radiation source to emit a reference beam, wherein the beam combiner combines the electromagnetic radiation from the additional electromagnetic radiation source with the object beam.

15. The system of claim 14, further comprising a parabolic mirror having a focus point, wherein the electromagnetic radiation source is located at an optically significant distance from the focus point of the parabolic mirror, and oriented to reflect electromagnetic radiation off the parabolic mirror onto an object.

16. The system of claim 15, wherein the optical subsystem further comprises a plate that defines an aperture between the parabolic mirror and the optical subsystem.

17. The system of claim 15, wherein parabolic mirror has a optical axis and wherein the object is located such that it does not intersect with the optical axis.

18. The system of claim 12, wherein the processor adjusts the mirrors on the digital micromirror device.

19. The system of claim 12, wherein the electromagnetic radiation source is a tunable laser.

20. The system of claim 19, wherein the electromagnetic radiation source is a tunable laser that outputs wavelengths selected from the group consisting of 1.3 to 1.5 microns and 10-20 microns.

21. The system of claim 12, wherein the processor creates a super-resolution image from multiple images.

22. An interferometric imaging system, comprising:
an electromagnetic radiation source;
a digital micromirror device that reflects the emitted electromagnetic radiation onto an object;
an optical subsystem, wherein the optical subsystem focuses the electromagnetic radiation reflected from the object into an object beam;
a detector that receives the object beam and the reference beam from the optical subsystem; and
a processor that processes images from the detector.

23. The system of claim 22, wherein the optical subsystem comprises a lens, wherein the lens collimates specularly reflected electromagnetic radiation, and focuses non-specularly reflected electromagnetic radiation.

24. The system of claim 23, wherein the optical subsystem comprises a beam combiner and an additional electromagnetic radiation source to emit a reference beam, wherein the beam combiner combines the electromagnetic radiation from the additional electromagnetic radiation source with the object beam.

25. The system of claim 22, wherein the processor adjusts the mirrors on the digital micromirror device.
